(19) United States
(12) Patent Application Publication
(10) Pub. No.: US 2008/0120266 A1
(43) Pub. Date: May 22, 2008

(54) Software method for solving systems of linear equations having integer variables

(76) Inventor: Jean-Paul Theis, Erpeldange (LU)

Correspondence Address: Jean-Paul Theis, Porte des Ardennes , 1, Erpeldange, L-9145, omitted

(21) Appl. No.: 11/603,056

(22) Filed: Nov. 22, 2006

(51) Int. Cl. G06N 5/02; G06F 17/11

(52) U.S. Cl. 706/47; 708/446

(57) ABSTRACT

This invention describes a software method for computers for solving integer programming problems containing systems of linear equations where part of or all of the variables may take only integer values. Said software method consists of 2 main steps. First, the arithmetic binary decision diagrams associated to the equations of the system are constructed. A solution to any of said equations is determined by finding an allowed path through the associated arithmetic binary decision diagram. Then, solutions common to all equation of the system are determined by searching for common paths between the arithmetic binary decision diagrams of the equations. Searching for common paths between said arithmetic binary decision diagrams is done by determining correspondences between the nodes of said arithmetic binary decision diagrams.

### 1. FIELD OF THE INVENTION

This invention describes a software method for computers for solving integer programming problems containing systems of linear equations where part of the variables may take only integer values. Integer programming has many different practical applications, e.g. in production cost optimization, product development, logistics and business methods, in constructing and detecting arbitrarily large prime numbers for cryptographic applications.

### 2. PRIOR ART

Integer programming is a special case of linear programming where the variables (or unknowns) can take only integer values. Whereas efficient algorithms for linear programming has been developed as early as 1950, e.g. the simplex algorithm, integer programming appeared far more hard to implement efficiently. In average, the simplex algorithm has polynomial complexity. The complexity of an algorithm is measured in terms of basic operations the algorithm has to execute in order to solve a problem. Polynomial complexity means that the number of operations grows like O((n·k)^{c}), where O( ) denotes the mathematical sign for ‘order of magnitude’, n denotes the number of variables and k denotes the number of equations, and c is a constant whose value does not depend on n.

For integer programming, no polynomial complexity algorithm is known. State-of-the-art algorithms include branch-and-bound methods, cutting plane (Gomory) methods and explicit/implicit enumeration methods. All of these algorithms have exponential complexity and have an unacceptable run-time for optimization problems involving a few thousand variables.

Integer programming has numerous practical applications. One of the most famous is the traveling sales man problem where a salesman has to visit a certain number of clients at different locations within a given period of time. The underlying optimization problem consists in finding the optimal route such the clients visited within the given time are maximized. The traveling sales man problem can be generalized to other optimization problems common in logistics and transportation, which is also closely related to business methods for logistic and transportation companies.

Another field of applications of integer programming is that of production line optimization, e.g. where a robot-controlled production line consisting of a number of robots able to assemble a certain number of products. Each product requires a different number of assembly steps on each robot. The underlying optimization problem consists in distributing the assembly steps of each product to the different robots such that the total number of assembly steps, e.g. the production costs, are minimized and the total number of products assembled in a certain time, e.g. the sales revenues, are maximized.

Another important field of application is product development, in particular chip design in the semiconductor industry. Chip design requires electronic design automation (EDA) tools for placement and routing of the semiconductor devices, e.g. transistors or logic gates, on a silicon die. A common flavor of the underlying optimization problem often consists in placing and routing the transistors on the silicon die in such a way that the total area occupied by the transistors is minimized and the sum of all wires connecting the transistors with each other is minimized. Part of this optimization problem can be formulated in the form of an integer programming problem where part of the integer variables are the coordinates of each transistor to be placed on the silicon die.

Another important field of application are cryptographic systems relying on large prime numbers in order to encrypt and decrypt messages and information. An efficient algorithm for integer programming allows to construct and detect arbitrarily large prime numbers efficiently.

### 3. BRIEF DESCRIPTION OF THE SEVERAL VIEWS OF THE DRAWINGS

FIG. 1 shows the ABDD associated to the first equation.

FIG. 2 shows details of the construction of the initial ABDD and of the rest of the ABDD of the first equation. The exception nodes are in black color. The result-nodes are in gray color. The first equation takes 12 distinct values: {0, −28, −12, −9, 9, −40, −37, −19, −21, −3, −49, −31}.

FIG. 3 shows the ABDDs of the second and third equation. The second and third equation takes each 15 distinct values.

### 4. DETAILED DESCRIPTION OF THE INVENTION

The present invention describes a novel and efficient algorithm for integer programming. The description of the invention aims at keeping the burden of mathematical notation and formalism at a minimum and giving, wherever possible, the priority to small and constructive examples from which the formal algorithm becomes obvious.

Consider the integer minimization problem consisting of a system of k linear equations of the form a_{1,l}−x₁+ . . . +a_{n,l}·xₙ=bₗ, I=1, . . . k, having n binary variables xₘ m=1 . . . n, coupled to an objective function

$$min {\sum }_{m = 1 … n} {c}_{m} \cdot {x}_{m} .$$

The coefficients a_{j,l}, cⱼ and bₗ, j=1, . . . n, l=1, . . . k, belong to the set of positive and negative integers. Each binary variable xₗI=1 . . . n can take the value 0 or 1. For notational convenience, the coefficients a_{j,l} j 32 1, . . . n, I=1, . . . k will be called ‘variable-coefficients’.

In the following, ‘C’ will denote the absolute value of the biggest positive or negative variable-coefficient. By definition, a solution s of an equation or of the whole system is a set containing all those variables having 1 as value in that solution, e.g. s:={xₘ, m=1 . . . n|xₘ=1 and for I=1, . . . k: a_{1,I}·x₁+ . . . +a_{n,I}·xₙ=b_{I}}.

The complexity of the algorithm is given in terms of the following basic operations (or steps):
1. basic arithmetic and relational operators (e.g. multiplication ‘·’, addition ‘+’, subtraction ‘−’, division with or without rest ‘/’, bigger or equal to ‘>=’, smaller or equal to ‘<=’, equal to ‘=’; different from ‘≠’, element of ‘ε’, included in ‘⊂’, union ‘∪’) taking as arguments either coefficients, variable labels, or words of up to O(n·log n) bits
2. bitwise logical operators (e.g. bitwise AND, OR, NOT) taking as arguments words of up to O(n·log n) bits
3. read/write accesses to random access memories having 0(n) entries and storing up to O(n·log n) bits per entry

Unless specified otherwise, ‘log’ denotes the logarithm of base 2. Furthermore, the relational operators (e.g. ‘<=’ and ‘<’) define a total order over negative and positive integers such that f. ex. −4<−3, −2<1 and 2<3 hold. In this way, ‘max’ and ‘min’ operators are also well defined over negative and positive integers. Since the algorithm involves directed graphs, we denote by G(E,V) a directed graph G having V and E as set of nodes and edges respectively. A (directed) edge from some node q to some node r will be denoted by a 2-tuplet (q, r). Similarly, a path of containing q nodes is denoted by a q-tuplet.

Without loss of generality (w.l.o.g.), it is assumed that each binary variable x₁I=1 . . . n has at least one non-zero coefficient a_{j,k} in one or more of the k equations.

The algorithm consists of 2 main steps:
1. Finding out whether a single diophantine equation of the system has a solution by constructing the arithmetic binary decision diagram (ABDD) associated to that equation. An ABDD is a more general form of BDD: it contains cycles and has two different kinds of nodes. The ABDD of a linear diophantine equation with n binary variables has o(C·n²) nodes and o(C·n³) edges and its construction has complexity bounded by o(C·n³ log n). Finding a solution to the given equation consists in finding an allowed path through the ABDD and has complexity bounded by o(C·n⁴·log n).
2. Finding out whether the system of k diophantine equations has a solution by searching for common paths between the k ABDDs of the k equations of the system. Because all ABDDs are constructed by using the same construction algorithm, searching for common paths between the k ABDDs is reduced to finding correspondences between nodes of the different ABDDs and has complexity bounded by o(C·k·n⁴).

Each main step is now described in detail.
Step 1. Finding out whether a diophantine equation of the system has a solution by constructing the ABDD associated to that equation

Consider a linear diophantine equation a₁]x₁+ . . . +aₙ·xₙ=b of the system. We denote by

$${\sum }_{+}$$

and Σ₋ the sum of all positive and negative coefficients respectively. It is clear that the equation a₁·x₁+ . . . +aₙ·xₙ can take at most

$${\sum }_{+} - {\sum }_{-} = o ( C \cdot n )$$

different values. Hence, if it is possible to compute these values in polynomial time, it is possible to decide in polynomial time whether the given equation has a solution or not. The following theorem shows that this is possible by introducing a more general form of binary decision diagram called ‘arithmetic’ binary decision diagram (ABDD). An ABDD is a kind of cyclic binary decision diagram having two different kind of nodes (see below for details). The proof of the theorem is constructive and shows that computing these o(C·n) different values is done by constructing an ABDD associated to the given equation.

Theorem 1:

Given a linear diophantine equation a₁·x₁+ . . . +aₙ·xₙ=b, x₁ . . . xₙ being n binary variables. An arithmetic binary decision diagram (ABDD) having o(C·n²) nodes and o(C·n³) edges and containing all the solutions of the given equation can be constructed in o(C n³·log n) steps.

Proof and Algorithm:

The rational of the construction of an ABDD can be summarized as follows:
1. Start with a list containing the variables x₁, x₂, . . . xₙ with their associated coefficients.
2. Add the coefficient of x₁ to the coefficient of each sub-sequent variable x₂, . . . xₙ and store each generated sum (e.g. a₁+a₂, a₁+a₃, . . . a₁+aₙ) as new member of the list; if any two members have the same sum, then merge the two members;
3. Add the coefficient of x₂ to the coefficient of each sub-sequent variable x₃, . . . xₙ and to each new member (e.g. sum) generated in step 2. and store each generated sum as a new member of the list; if any two members have the same sum, then merge the two members;
4. Add the coefficient of x₃ to the coefficient of each sub-sequent variable x₄, . . . xₙ and to each new member (e.g. sum) generated in steps 2. and 3. and store each generated sum as a new member of the list; if any two members have the same sum, then merge the two members; . . .
N. Add the coefficient of xₙ₋₁ to the coefficient of the sub-sequent variable xₙ and to each new member (e.g. sum) generated in steps 2., and 3. . . . and N−1 and store each generated sum as a new member of the list; if any two members have the same sum, then merge the two members;

It is straightforward to verify that the construction is exhaustive, e.g. it contains all possible combinations (e.g. sums of coefficients) of one or more of the n variables, and has complexity bounded by o(C·n²·log n) steps. Furthermore, the list contains all o(C·n) distinct equations values (e.g. sums of coefficients) which can be taken by the diophantine equation. However, the construction leads also to non-allowed combinations of variables. Additional construction constraints have to be added such that non-allowed combinations can be filtered out in further steps. The rest of the proof gives the details of how to translate these operations into an ABDD with the claimed properties.

The details of the construction of the ABDD are as follows:

As indicated before, the ABDD is constructed by working on a dynamic and linked list. We associate nodes of the ABDD to members of the list, and vice versa. During construction, we add members and links to the list, or correspondingly, nodes and edges to the ABDD. A link within the list associates (or maps) a member of the list to one or more other members of the list. As mentioned before, a (directed) link between two members p and q corresponds within the ABDD a (directed) edge from node p to node q. It is clear that, for an efficient implementation on computers, a link between two members p and q may be implemented by a pointer associated to member p and which points to the address of member q within the list.

Each member of the list (e.g. each node of the ABDD) is unequivocally labeled with some integer number (The node labeling is omitted in the algorithm specification below). There are two kinds of nodes: ‘operand’-nodes and ‘result’-nodes. An ‘operand’-node (with label) p has an associated node value nvₚ equal to the index of a variable of the diophantine equation. A ‘result’-node (with label) p has an associated equation value evₚ corresponding to one of the o(C·n) distinct values that the diophantine equation can take.

For the algorithm specifications which follow, a sequential programming language very similar to the programming language C++ is used. Brackets { . . . } denote a group of statements to be executed sequentially. However, the brackets are also used to define sets (including the empty set { }). Program steps labeled by 1. 2. 3. . . . have to be executed in the indicated order. If—conditions are placed between parentheses ( ). Comments are placed between /* . . . */.

For search efficiency purposes, during construction, the list may be kept ordered with respect to node values or node labels.

Construction Algorithm:

The initial list (e.g. the initial ABDD) contains 2·n+1+(n−1) n nodes: 1 root-node, n initial operand-nodes, n initial result-nodes, ½·(n−1)·n exception nodes and their associated result-nodes. It is constructed as follows:

```
1. Member 0 (e.g. with node label 0) of the list is the root-node having equation value 0. Member 1 of
  the list is the operand-node with nv₁ = 1 (e.g. equal to the index of x₁), member 2 of the list the
  operand-node with nv₂ = 2 (e.g. equal to the index of x₂)... until reaching member n of the list being
  the operand-node with nvₙ = n (e.g. equal to the index of variable xₙ).
2. For j = 1 to n do :
      { create an edge from the root node to initial operand-node j;
        create an edge from the operand-node with j to a new result-node p with evₚ = aⱼ;}
              /* An unequivocally defined result-node p with evₚ = aⱼ is called an ‘initial’ result-node */
3. For i = 1 to n −1 do :
        For j > i do :
          { create an edge from result-node p with evₚ = aᵢ to a new operand-node q with nv_{q} = j;
            /* operand-node q is called exception node. There are ½ .(n−1).n exception nodes
            in total */
          create an edge from node q to a new result-node m with evₘ = aⱼ + aᵢ;
          in_{q} = i ; L_{q} = {j};
      }
```

```
For j = 2 to n do :
  For each non-initial result-node q of the list do :
    if ((j ∉ ∩ₘ Lₘ, m running over the source-nodes of all incoming edges to node q) /* no unnecessary wrong paths */
```

| | |
|---|---|
| AND (in_{q} < j )) do : | /* avoid repetition of combinations of variables */ |

```
      { create a new operand-node m with nvₘ = j ;
        Lₘ = L_{q} ∪ {j};
        create an edge from node q to node m;
        create a new result-node p with evₚ = ev_{q} + aⱼ ;
        Lₚ = ∩ᵣ Lᵣ , r running over the source-nodes of all incoming edges to node p ;
        create an edge from node m to node p;
              /* the place where the new member p is put into the list is such that the list remains */
            /* ordered; if another member p′has the same node value as p, p is placed behind p′ */
        inₚ = in_{q} ;
```

| | |
|---|---|
| if ((evₚ = evᵣ ) AND (inₚ = inᵣ)) do : | /* r being the member prior to p in the list */ |

```
          { any edge from some node s to node p is redirected to r ;
            member p is retrieved from the list;
          }
      }
End of Algorithm
```

The rest of the ABDD is constructed as follows:

As can be seen form the specification, the label of each of the n initial operand-nodes 1 . . . n is propagated by the program variable inₚ to each node p lying on a path from that initial operand-node.

Consider the inner For-loop of the construction code of the rest of the ABDD. Since only result-nodes having same equation value and lying on paths emanating from a same initial operand-node are merged, it is clear that at most o(C·n) operand- and result-nodes and at most o(C·n²) edges are created per initial result-node. Therefore, the whole ABDD has o(C·n²) nodes and o(C·n³) edges and the construction of the ABDD takes o(C·n³ log n) steps.

By definition, the graph containing all the nodes and edges lying on a path from initial operand-node p is called the sub-graph of node p.

As mentioned above, the construction is exhaustive (e.g. the ABDD contains all solutions of the equation) because with each iteration k of the outer For-loop of the construction code of the rest of the ABDD we construct all possible combinations of variables (e.g. all possible sums of the associated variable-coefficients a₁ . . . aₖ). To each combination of variables corresponds a ‘constructed’ path through the ABDD. (The definition of a constructed path is given below.) Each result-node represents the sum of coefficients of variables found on each path from the root-node to that result-node.

During construction of the ABDD, we store the sequence of construction of edges and nodes in form of a sequential list of node labels Seq(V) and edge labels Seq(E) respectively. E.g. Seq(V)={1, 2, 4, 3, 9, 10 . . . } means that first node 1 is constructed, then node 2, then node 4, then node 3 . . . Seq(E)={(1,2), (1,4), (2,4), (2,3) . . . } means that first the edge from node 1 to node 2 is constructed, then the edge from node 1 to node 4, then the edge from node 2 to node 4 . . .

By definition, a constructed path is a path whose sequence of nodes and edges obeys the sequence (e.g. the order) of nodes and edges as given by Seq(V) and Seq(E) respectively. E.g., consider the above Seq(V) and Seq(E). The path of 4 nodes (1, 2, 3, 9) obeys the sequence as given by Seq(V), where as the path of 4 nodes (1, 2, 9, 3) does not. In the remaining of the description, we only consider constructed paths.

Since only result-nodes having same equation value and emanating from a same initial operand-node are merged, the sub-graphs of any two initial operand-nodes are disjoint, e.g. they have no node and no edge in common.

As mentioned before, the construction contains forbidden (wrong) paths. However, because the sub-graphs of initial operand-nodes are disjoint and due to the fact that, during construction, operand-nodes are successively added to the rest of the ABDD in ascending variable label order, wrong paths of the ABDD satisfy the following property:

I. Any Wrong Path Contains:
either two consecutive operand-nodes having same node value or exactly one operand-node having same node value as the exception node on that path

By construction, all other paths are allowed (correct) paths and they represent all the solutions to the given equation. For the same reason as before, allowed paths satisfy the following property:

II. Any Correct Path Respects the Same Variable Order if the Exception Node on that Path is Excluded

These properties of wrong and correct paths are essential in order to find a solution to any diophantine equation of the system as well as a solution common to all k equations of the system. □

### EXAMPLE

Consider the following system:

−28·x₁−12·x₂−9·x₃+9·x₄=? 1

22·x₁+14·x₂−11·x₃−5·x₄=? 2

−19·x₁−11·x₂−6·x₃+4·x₄=? 3

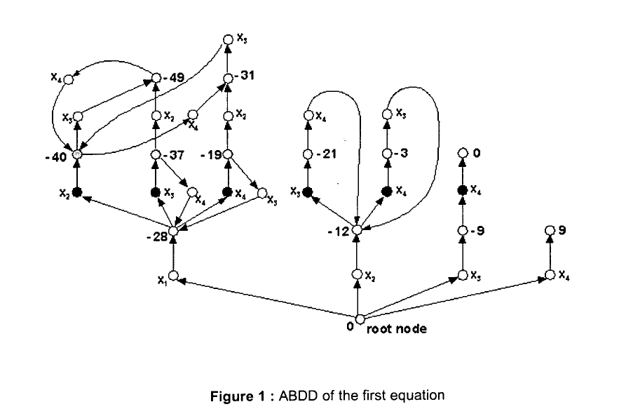

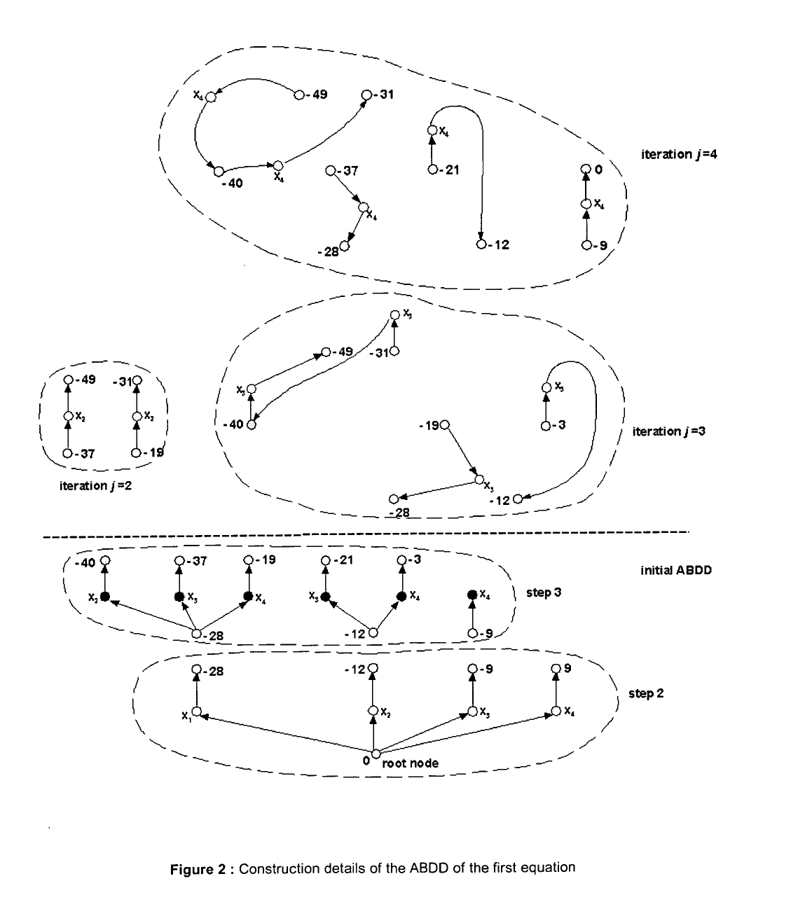

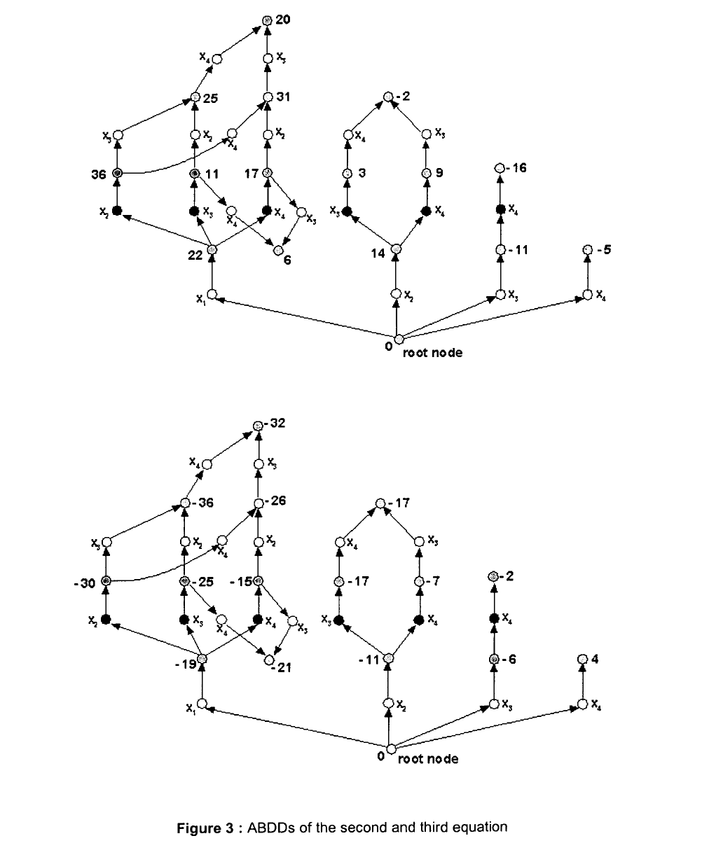

The interrogation marks will later be replaced by all possible values for which the system has a solution. The ABDD associated to the first equation is shown in FIG. 1. The construction of the initial ABDD and of the rest of the ABDD of the first equation is shown in FIG. 2. The exception nodes are in black color. The result-nodes are in gray color. The first equation takes 12 distinct values: {0, −28, −12, −9, 9, −40, −37, −19, −21, −3, −49, −31}. The ABDDs of the second and third equation are shown in FIG. 3. The second and third equation takes each 15 distinct values. End of example.

As mentioned above, an ABDD constructed with the before construction algorithm may contain forbidden paths. Trying to remove these forbidden paths from the graph would require graph transformations leading in general to an ABDD of exponential size. Instead, these forbidden paths can easily be ‘filtered-out’ by using properties I. and II. of wrong and correct paths mentioned in the above theorem. The following procedure gives the details.

In the following, we denote by a ‘reversed’ edge (p,q) a directed edge (q,p) traversed in the opposite direction from node p to node q.

### Procedure for Determining Whether a Diophantine Equation has a Solution Containing Some Exception Node (with Label) EX:

1. During construction of the ABDD=G(V,E), use a simple ‘forward propagation’ algorithm which propagates the labels of each exception node to each node (to operand- and result-nodes) encountered on any path outgoing from that exception node. (For ease of implementation of step 3. below, the label of each exception node is also propagated on the (unique) path from the root-node to that exception node.) Since the sub-graphs of the initial operand-nodes are disjoint and since a sub-graph contains at most n−1 exception nodes, in each sub-graph up to n−1 exception nodes have to be propagated (in form of a list L1ₚ) along each edge to any node p of a sub-graph.

2. During construction, store the sequence of construction of edges and nodes of each sub-graph separately in form of a sequential list of node labels Seq(V) and edge labels Seq(E) respectively.

3. After the ABDD is constructed, determine whether there exists a sub-graph which contains exception node EX and a result-node w with ev_{w}=b. If this sub-graph does not exist, then the diophantine equation has no solution. Otherwise, use a ‘backward-propagation’ algorithm (see specification below) which traverses the sub-graph from the result-node w with ev_{w}=b backwards to the root-node by using the reverse sequence of construction of edges and nodes and by propagating either a ‘0’ or a ‘1’ along reversed edges backwards to the root-node. If a ‘1’ gets propagated from the result-node w with ev_{w}=b down to the root-node by passing through exception node EX, then there exists a solution to the given diophantine equation containing exception node EX. Otherwise there exists no solution containing exception node EX. A correct path containing the operand-node values making up a solution is called a ‘solution-path’ in the following.

4. Since the ABDD has ½·(n−1)·n exception nodes, repeat step 3. for each exception node EX of the list of ½·(n−1)·n exception nodes. If there exists no solution containing any of the exception nodes, it remains to check whether there is a solution equal to {x₁} or {x₂} or {x₃} . . . or {xₙ}, because all other combinations of variables have been checked before. If not, then the diophantine equation has no solution.

5. If there exists a solution containing an exception node EX, determine one solution path (of maybe many possible) by tracking forward from the root-node through exception node EX up to the result-node w with ev_{w}=b, and where such a solution path is found by tracking-forward only along edges which have gotten a ‘1’ propagated along them (in the reverse direction) during steps 3. and 4, and by using property I. of wrong paths in order to check, edge by edge, that the path up the current edge is a correct path.

6. In order to determine a solution minimizing the objective function of the above minimization problem, track forward as in step 5., but additionally along each possible solution path from the root-node, and additionally by propagating, from node to node along each possible solution path, the partial objective function value, e.g. the sum of the coefficients of the variables encountered up to the current node on each path. When two or more solution paths cross or converge at a same result-node, propagate to all outgoing edges from that result-node the smallest objective function value of the objective function values propagated along each incoming edge to that result-node. Since the sub-graphs of the initial operand-nodes are disjoint and since each sub-graph contains o(C·n) nodes and o(C·n²) edges, each sub-graph can be partitioned into at most o(C·n) non-crossing or non-converging paths containing at least one operand-node and one result-node. Therefore, the complexity for finding a solution containing exception node EX and minimizing the objective function is still bounded by o(C·n²·log n).

7. Repeat step 6. for each exception node EX of the list of ½·(n−1)·n exception nodes and check for {x₁}, {x₂},{x₃} . . . {xₙ} as possible solutions, in order to determine all the solutions minimizing the objective function.

As mentioned above, the backward-propagation algorithm of step 3. exploits property I. of wrong paths in order to propagate the ‘1’s backwards to the root-node along reversed and correct paths. Its implementation is straightforward

Backward-Propagation Algorithm

```
For each reversed edge (p,q) taken in the order as given by the reversed list Seq(E) do :
  { if (p is a result-node encountered prior to the result-node w with ev_{w} = b) do :
        {Propagate a ‘0’ along reversed edge (p,q) and (q, t) to result-node t;
        mark the reversed edges (p, q) and (q, t) as ‘visited’;}
    if (p is the result-node p with evₚ=b) do :
      { if (((nv_{q} ≠ nv_{EX}) OR (node q is the node EX)) AND (node EX ∈ L1_{q})) do :
            propagate a ‘1’ along the reversed edges (p, q) and (q, t) to result-node t;
      else do : propagate a ‘0’ along the reversed edges (p, q) and (q, t) to result-node t;
      mark the reversed edges (p, q) and (q, t) as ‘visited’;
      }
    if (p is a result-node encountered after the result-node w with ev_{w} = b) do :
      if (p is the root-node) do :
        if (there exists a ‘visited’ reversed incoming edge (s,p) having a propagated ‘1’) do :
          {the diophantine equation has a solution containing node EX; exit;}
        else do : {the diophantine equation has no solution containing node EX; exit;}
      else do :
        if (there exists a ‘visited’ reversed incoming edge (s,p) having a propagated ‘1’ and
          such that nvₛ ≠ nv_{q}) do :
            { if (((nv_{q} ≠ nv_{EX}) OR (node q is the node EX)) AND (node EX ∈ L1_{q} )) do :
              propagate a ‘1’ along the reversed edges (p, q) and (q, t) to result-node t;
              else do : propagate a ‘0’ along the reversed edges (p, q) and (q, t) to result-node t;
            mark the reversed edges (p, q) and (q, t) as ‘visited’;
            }
  }
End of Algorithm
```

It is also straightforward to verify that the backward propagation algorithm has complexity bounded by o(C·n²). Therefore, the above procedure (steps 1. to 7.) has complexity bounded by o(C·n⁴·log n).
Step 2. Finding out whether the system of k diophantine equations has a solution by searching for common paths between the k ABDDs of the k equations of the system

Definition and Theorem 2:

Given any two diophantine equations a_{1,1}−x₁+ . . . +a_{n,1}·xₙ=b₁ and a_{1,2}·x₁+ . . . +a_{n,2}·xₙ=b₂ of the system, with their associated ABDD₁=G(V₁,E₁) and ABDD₂=G(V₂,E₂) respectively, constructed according to the above construction algorithm. Assume that nvᵢ=b₁ and nvⱼ=b₂ for some node i ε V₁(ABDD₁) and for some node j ε V₂(ABDD₂).
1. By definition, the two equations have a common solution iif there exists an allowed path through ABDD₁ from the root-node to node i and an allowed path through ABDD₂ from the root-node to source node j such that the two (directed) paths are identical
2. By definition, two paths are identical iif the sequence of the node values on each path is identical.

Two identical paths represent a path (e.g. a solution) which is common to both equations

Since the same construction algorithm is used for both ABDDs, the following properties hold:
3. Any correct path is common to both ABDDs
4. To each node of the initial ABDD of one equation corresponds exactly one node of the initial ABDD of the other equation
5. To each edge of the initial ABDD of one equation corresponds exactly one edge of the initial ABDD of the other equation
6. To each node of the rest of the ABDD of one equation correspond one or more nodes of the rest of the ABDD of the other equation
7. To each edge of the rest of the ABDD of one equation correspond one or more edges of the rest of the ABDD of the other equation

It is obvious that this definition and theorem holds not only for two equations, but for an arbitrarily large number of equations of the system. □

Consider a node p ε Vᵣ(ABDDᵣ) of the ABDDᵣ associated to some equation r. We denote by S_{p,q} the set of nodes of another equation q of the system corresponding to node p of equation r. RN_{q} denotes the root-node of ABDD_{q} associated to equation q.

The correspondence between nodes and edges of the k ABDDs of the k equations of the system may be determined as follows (steps 1. to 2.):

```
1. For each ABDD = G(V,E) of the k equations do :
        For each node p ∈ V do :
          { determine whether node p is an operand-node or a
          result-node;
            if (node p is operand-node) do : determine its node
            value; /* e.g. the label of the associated variable */
            determine all incoming and outgoing edges with
            their source and sink nodes respectively;}
2. Consider Vᵣ(ABDDᵣ) and Eᵣ(ABDDᵣ) of some equation r ;
  For each equation u ≠ r do : S_{RN}_{r′}ᵤ = RNᵤ;
  For each node p ∈ Seq(Vᵣ) do :
        For each outgoing edge (p,q) ∈ Eᵣ(ABDDᵣ) do :
            For each equation u ≠ r do :
                For each node p′ ∈ S_{p,u} do :
                    if (node p′ is a result-node) do :
                        { search for (p′,q′) ∈ Eᵤ(ABDDᵤ) such that
                        nv_{q′} = nv_{q};
                        S_{q′,u} = S_{q′,u} ∪ { q′};}
                    else do :
                        { search for the unique (p′,q′) ∈ Eᵤ(ABDDᵤ);
                        S_{q′,u} = S_{q′,u} ∪ { q′};}
```

Since by construction S_{p,u} has at most n elements for any p and u, step 2. has complexity bounded by o(C·k·n⁴). From this definition and theorem, one immediately derives the following

Theorem 3:

The above system of k diophantine equations a_{1,I}·x₁+ . . . +a_{n,I}·xₙ=b_{I}, I=1, . . . k has a solution iif there exists a result-node p ε Vₜ(ABDDₜ) of some equation t such that:
1. evₚ=bₜ
2. there exists a solution path through ABDDₜ from the root-node to node p
3. For each equation u≠t there exists p′ ε S_{p,u} such that ev_{p′}=bᵤ

The complexity for finding a solution to the system is bounded by o(C·k·n⁴)+o(C·n⁴ log n).

Proof and Algorithm:

By virtue of property 3. of the theorem 2, it is clear that if conditions 1. and 2. are satisfied, then any solution path satisfying condition 2. is common to all the other k−1 ABDDs. Therefore, it remains to check for condition 3. in order to find a solution to the system. Checking for condition 1. has complexity bounded by o(C·n²), checking for condition 2. is done by using the above procedure (steps 1. to 7.) and has complexity bounded by o(C·n⁴·log n), checking for condition 3. is done after determining the correspondences between nodes and edges of the k ABDDs and has complexity bounded by o(C·k·n⁴). □

### EXAMPLE

We come back to the previous system of 3 diophantine equations:

−28·x₁−12·x₂−9·xₑ30 9·x₄=? 1

−19·x₁−11·x₂−6·x₃+4·x₄=? 2

22·x₁+14·x₂−11·x₃−5·x₄=? 3

By using the correspondences between the nodes of the 3 ABDDs, we can now determine, in form of triplets, all combinations of right hand side values of the 3 equations for which the system will have a solution. The first, second and third value in each triplet indicates the equation value of the associated result-node in the first, second and third ABDD respectively.
(0,0,0)
(−28, −19, 22)
(−12, −11, 14)
(−9, −6, −11)
(9, 4, −5)
(−40, −30, 36)
(−37, −25, 11)
(−19, −15, 17)
(−21, −17, 3)
(−3, −7, 9)
(0, −2, −16)
(−49, −36, 25)
(−31, −26, 31)
(−40, −32, 20)
(−28, −21, 6)
(−12, −17, −2)

There are just three 1-to-2 node correspondences (in bold face):
1. the result-node of the first ABDD having equation value 0 corresponds to node couples (0,0) and (−2, −16), each couple containing a result-node of the second and third ABDD respectively
2. the result-node of the first ABDD having equation value −28 corresponds to node couples (−19,22) and (−21,6), each couple containing a result-node of the second and third ABDD respectively
3. the result-node of the first ABDD having equation value −12 corresponds to node couples (−11,14) and (−17, −2), each couple containing a result-node of the second and third ABDD respectively

End of Example.

Concluding Remarks

Adding up the complexities of all involved steps discussed so far leads to a total complexity of o(C·k·n⁴)+o(C·n⁴·log n) for finding a solution to the above minimization problem. It is clear that, after applying main step 1., it turns out that an equation of the system has no solution, then there is no solution to the whole system and main step 2. can be skipped.

Finally, one should note that the whole algorithmic discussed so far remains valid in the case that the variable-coefficients are non-integer numbers, e.g. fractional or floating-point numbers.

### 5. SUMMARY OF THE INVENTION

This invention describes a software method for computers for solving integer programming problems containing systems of linear equations where part of or all of the variables may take only integer values.

What is claimed is:

1. a software method for solving a system of linear equations having integer variables, where said method consists of doing one or both of the following 2 steps in the indicated order:
I. For one or more equations of said system construct the arithmetic binary decision diagram associated to each said equation
II. Find out whether part of or all of the equations of said system have a common solution by searching for common paths between the arithmetic binary decision diagrams of said equations

2. a software method as in claim 1, where a solution of a said equation is determined by finding an allowed path through the associated arithmetic binary decision diagram

3. a software method as in claim 1, where said common paths are determined by determining correspondences between nodes of said arithmetic binary decision diagrams
